(19) United States
(12) Patent Application Publication
(10) Pub. No.: US 2022/0351226 A1
(43) Pub. Date: Nov. 3, 2022

(54) SYSTEM AND METHOD FOR ASSISTED PURCHASING, SHIPPING OF PACKAGES, AND SUBSIDIZING AIRFARE VIA PACKAGE DELIVERY

(71) Applicant: Larren Peart, Sunrise, FL (US)

(72) Inventor: Larren Peart, Sunrise, FL (US)

(21) Appl. No.: 17/492,204

(22) Filed: Oct. 1, 2021

Related U.S. Application Data
(60) Provisional application No. 63/181,072, filed on Apr. 28, 2021.

(51) Int. Cl. G06Q 30/02; G06Q 30/06

(52) U.S. Cl. CPC G06Q 30/0208; G06Q 30/0641

(57) ABSTRACT

A system and method for subsidizing airfare of a traveler for transporting a package as a personal luggage. The disclosed system can provide a traveler interface for travelers traveling to another country to register themselves for transporting the packages. A buyer interface can be provided that allows the buyers to buy goods and choose the travelers for shipping their goods purchased from another country.

### CROSS-REFERENCE TO RELATED APPLICATIONS

This application claims priority from the U.S. provisional patent application Ser. No. 63/181,072, filed on Apr. 28, 2021, which is incorporated herein by reference in its entirety.

### FIELD OF INVENTION

The present invention relates to a system and method for shipping goods to a different state or another country, and more particularly, the present invention relates a system and method to assist buying an item, quick delivery of the item to the buyer in a different state or country through flight and subsidizing airfare on becoming a transporter of goods as luggage.

### BACKGROUND

Teleshopping and e-commerce have gained a significant market share with more and more people buying online. Logistics has played an important role in the success of e-commerce by providing doorstep delivery of goods from the warehouses to the buyer's address. The world has become a global market wherein a user while sitting at the comfort of his home can check different goods sold by sellers around the world on e-commerce platforms. However, the expanse of e-commerce is limited by logistics availability. Available logistics are good for transporting items intrastate and interstate. Very few e-commerce platforms support shipping goods globally. Still, the shipping costs are very high and delivery time for the goods is also a disappointment of many customers.

Thus, a need is appreciated for a system and method that can make the global shopping experience both economical and faster. A need is appreciated for a system and method that allows the buyers to receive their global purchases faster, and preferably in a day or two.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for online buying of goods from a different state or country.

It is another object of the present invention that system and method allow for global shopping of goods.

It is still another object of the present invention that the system and method provided for economical shipping of goods overseas.

It is yet another object of the present invention that the system and method allow for faster overseas shipping of goods.

It is a further object of the present invention that the system and method allow providing discounts on booking the flights.

In one aspect, disclosed is a system and method for purchasing goods remotely and delivering the goods to the customer faster and economically. The disclosed system can provide a traveler interface for travelers traveling to another country to register themselves for transporting the goods. A buyer interface can be provided that allows the buyers to buy goods and choose the travelers for shipping their purchased goods from another country.

In one aspect, a traveler interface may allow the travelers to book flights and avail discounts for their services to transport goods as luggage. Discounted fairs and like monetary awards can be determined by the dislcosed system and presented to the traveler through the traveler interface. Preferably, the traveler gets discounted airfare when they become a transporter of packages.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is an environmental diagram showing the disclosed system in communication with a traveler device, a buyer device, an agent device, and an admin device, according to an exemplary embodiment of the present invention.

FIG. 2 is a block diagram showing a system architecture, according to an exemplary embodiment of the present invention.

FIG. 3 shows an exemplary embodiment of the traveler module, according to an exemplary embodiment of the present invention.

FIG. 4 is a flow chart illustrating an exemplary embodiment of the buyer module, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

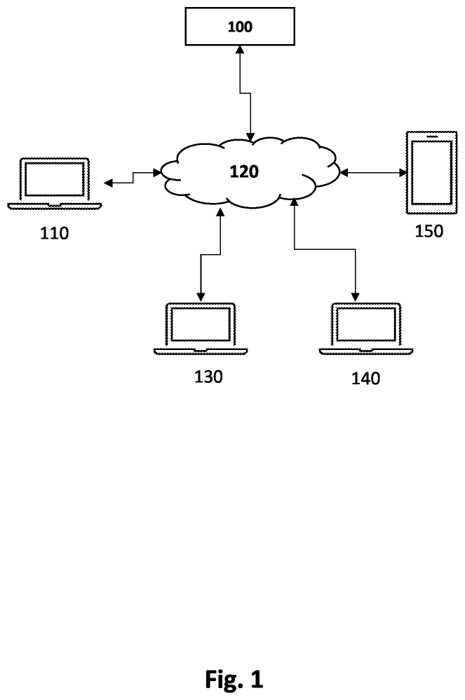

Disclosed is a system and method for assisting buyers to buy goods from a different state or country while providing fast and economical shipping of the goods from the seller to the buyer. The disclosed system can purchase goods on behalf of the buyer or can receive the goods from the seller on behalf of the buyer and can ship the goods to the buyer through a network of travelers. The goods can be shipped through flights in a day or two through flight. Referring to FIG. 1 which is an environmental diagram showing the disclosed system 100 in communication with a buyer device 110 through a network 120. The buyer device can be any computing device, such as a laptop and smartphone that the buyer can use to communicate with the disclosed system 100. The network can be a wired or wireless network or a combination of two. Suitable examples or networks can include a cellular network, Wi-Fi, Bluetooth, DSL, optical fiber connection, and like. Similarly, travelers through the traveler device 130 can connect with the disclosed system 100 through the network 120. It is to be understood that the same network is shown connecting the buyer device 110 and the traveler device 130 for illustration purposes only, however, a skilled person will appreciate that different devices can connect through different networks, moreover, the same device can connect through more than one network. Also, more than one device can simultaneously connect with the disclosed system 100. Also, can be seen in FIG. 1 are the agent device 140 that can also connect with the disclosed system 100 through the network 120. The agent device can also be any computing device, such as a laptop, desktop, smartphone, and like. An admin device 150 for managing the disclosed system can also be seen connected to the disclosed system 100 through network 120. The disclosed admin device 150 can also directly connect to the disclosed system 100.

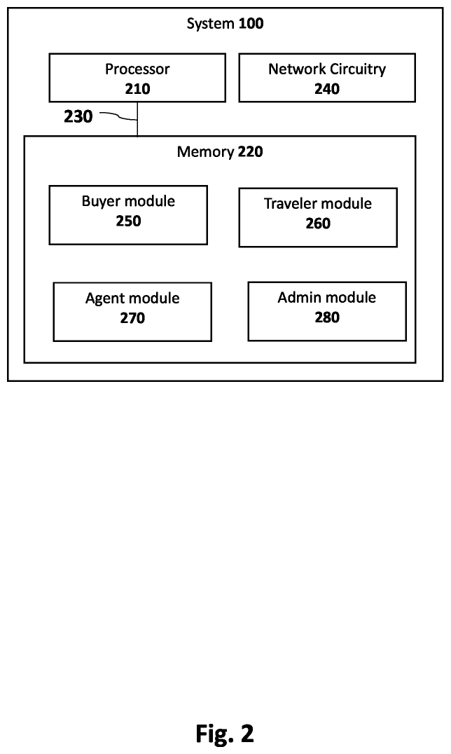

Referring to FIG. 2 which is a block diagram showing a system architecture. The disclosed system 100 can include a processor 210, a memory 220, the processor 210 connected with the memory 220 through a system bus 230. The processor 210 can be any logic circuitry that responds to, and processes instructions fetched from the memory 220. Suitable examples of the processors commercially available include Intel, AMD, Snapdragon, and like. The memory 220 may include one or more memory chips capable of storing data and allowing any storage location to be directly accessed by the processor 210. System 100 can also include a network circuitry 240 for connecting to a network. The network can be wired or wireless network. The wired network may include DSL and optical fiber lines. The wireless network may include Bluetooth®, Wi-Fi, WiMAX, and cellular networks including GPRS, LTE, CDMA, 3G, 4G, and 5G. The network can be a secure network or an unsecured network. As shown in FIG. 2, the memory includes modules according to the present invention for execution by the processor 210 to perform one or more steps of the disclosed method for assisting a buyer to buy goods globally and providing fast and economical shipment of the goods from the seller to the buyers in a different state or country through a network for travelers traveling by flights.

The memory 220 can include an interface module which upon execution by the processor can provide a buyer interface, an agent interface, a traveler interface, and an admin interface. The memory 220 can further include a buyer module 250 which upon execution by the processor can assist buyers to buy goods and also choose a traveler for transporting the purchased goods from the seller to the buyer. The memory 220 can further include a traveler module which upon execution by the processor can allow travelers to list themselves for transporting goods to the buyers. The memory may also include an agent module which upon execution by the processor can provide for buyers and travelers assistance in the purchase and transport of goods. The memory 220 may also include an admin module which upon execution by the processor can provide for programming of the disclosed system 100.

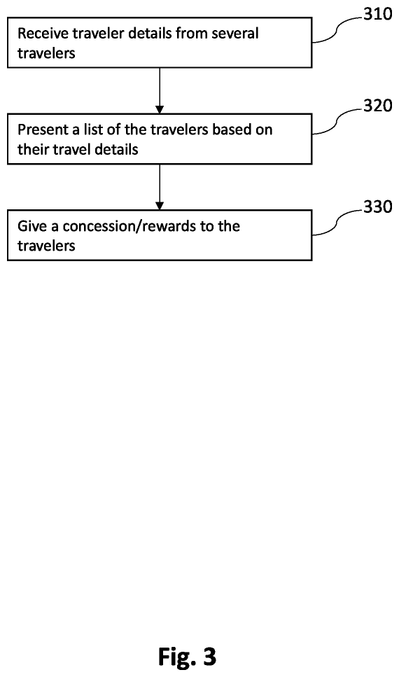

Referring to FIG. 3 which shows an exemplary embodiment of the traveler module 260. Travelers herein refer to people who wish to travel or are traveling to another state or country through flights for their purposes or reasons. For example, people going to a different country for vacations or meeting their relatives, or on a business trip. Such travelers can save on their travel costs by carrying goods not belonging to them like their luggage. For the services by the travelers to transport goods from the departure place to the destination place, the travelers can be reimbursed in the form of rewards, monetary benefits, discounts on airfare, and like. The traveler module, through the traveler interface, can receive travel details from different travelers interested to list enroll themselves with the disclosed system, at step 310. The travel details can include the departure date, time, and location, and the destination date, time, and location. Additionally, the travel details may also include the additional weight the traveler can carry besides his luggage. The disclosed traveler module 160 can prepare a searchable list of such travelers based on the travel details. Such travelers can be referred to herein as the network of travelers. The traveler module can present a list of travelers on a buyer device based on the product details from the buyer matching the traveler details, at step 320. The traveler module may also allow travelers to look for packages or shipments and choose the same.

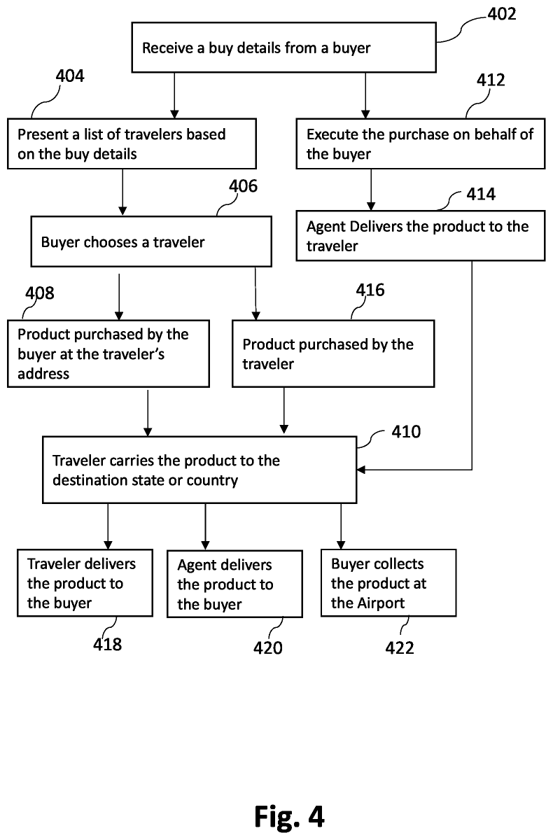

Referring to FIG. 4 which shows an exemplary embodiment of the buyer module 250 that can assist buyers to buy items globally and provide for shipments of the items. Perhaps, the disclosed system may allow buyers to buy the goods from sellers in other states or countries although the sellers may not be providing delivery services at the buyer's address or the delivery services are very long. In one case, the buyer can select an item to be purchased through an online website/listing of goods by the seller. For example, the buyer can choose a product on eBay or Amazon. The buyer module through the buyer interface can receive buy details from the buyer, at step 402. The buy details can include the product to purchase, the location of the seller from whom the product is to be bought, and the delivery address or the buyer's address. In one case, the buyer module can display a list of travelers on the buyer interface for the buyer to choose from, at step 404. The buyer can check the profiles of different available travelers that can transport the product to the buyer. The profile can include details of travelers, such as name, age, past deliveries, feedback, and like. the profile can also include information if the traveler can purchase the product on behalf of the buyer. In one case, the buyer through the buyer interface can select a traveler, at step 406. Thereafter, the buyer can place the order with the seller to deliver the goods to the selected traveler's address, at step 408. The traveler can receive the goods and carry them with their luggage on their scheduled flight, at step 410. The traveler can then deliver the goods directly to the consumer, at step 418. The traveler can deliver the goods at the consumer's address or can arrange for a place with the buyer to hand over the goods. Alternatively, an agent can receive the goods from the traveler at the destination airport and the agent can deliver the goods to the buyer, at step 420. Still, alternatively, the consumer can collect the goods by themselves at the airport from the traveler or the agent, at step 422.

In one alternative embodiment, instead of step 408, the traveler can purchase the goods on behalf of the buyer, at step 416. The traveler can then carry the goods at step 410 and deliver the goods as in steps 418, 420, or 422.

In one alternate embodiment, instead of step 404, the buyer module can execute the purchase on the behalf of the buyer, at step 412. The buyer module by execution of the agent module can purchase the goods on behalf of the buyer. The agent module can fill any gaps or steps from the purchase to the handling of the goods to the buyer. The agent can select the traveler and hand over the goods to the traveler, at step 414. The traveler can then carry the goods at step 410 and deliver the goods as in steps 418, 420, or 422.

Since the goods can be purchased by the agent or the traveler, the buyer may not have to convert the currency to pay for the goods. Similarly, the traveler can receive money for the goods the traveler paid for on behalf of the buyer and from the buyer. The traveler can get the local currency of their destination country from the buyer and can be saved from the currency conversions. Savings can also be made on custom duties and taxes.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for subsidizing an airfare for transporting a package from a first place to a second place as a luggage, the method implemented within a system comprising a processor and a memory, the processor coupled to the memory through a system bus, the method comprising the steps of:
receiving travel details from a plurality of travelers, the travel details comprise a departure location, an arrival location, and permitted additional luggage;
storing the travel details of the plurality of travelers in a database that can be queried;
receiving a buy detail from a buyer, the buy detail comprises a package description, the first place where the package is located, and the second place where the package has to be delivered;
obtaining a traveler of the plurality of travelers based on the buyer querying the travel details in the database and the buy detail;
assigning the package to the traveler for carrying from the first place to the second place as the luggage;
determining that the traveler delivered the package to the buyer; and
upon determining that the traveler has delivered the package to the buyer, causing presentation of a control selectable by the traveler, wherein selection of the control facilitates redemption by the traveler of a monetary award for delivering the package to the buyer.

2. The method according to claim 1, wherein the first place and the second place are in different regions or different countries.

3. The method according to claim 1, wherein the method further comprises the steps of:
providing a traveler interface on a traveler device for the plurality of travelers to provide the travel details;
facilitating, through the traveler interface, the traveler to book a flight from the first place to the second place; and
determining a discount on an airfare of the flight booked by the traveler, the discount based on the assigned package.

4. The method according to claim 1, wherein the method further comprises the steps of:
receiving of the package by the buyer from the traveler.

5. The method according to claim 1, wherein the method further comprises the steps of:
providing a buyer interface to receive the buy detail from the buyer; and
presenting an address of the traveler to receive the package from a seller.

6. The method according to claim 1, wherein the method further comprises the steps of:
providing a buyer interface to receive the buy detail from the buyer;
executing purchase of the package from a seller by an agent;
determining that the agent has received the package; and
upon determining that the agent has received the package, assigning the package to the traveler.

7. A system for subsidizing an airfare of a traveler for transporting a package from a first place to a second place as a luggage, the system comprises a processor and a memory, the system configured to implement the steps of:
receiving travel details from a plurality of travelers, the travel details comprise a departure location, an arrival location, and permitted additional luggage;
storing the travel details of the plurality of travelers in a database that can be queried;
receiving a buy detail from a buyer, the buy detail comprises a package description, the first place where the package is located, and the second place where the package has to be delivered;
obtaining a traveler of the plurality of travelers based on the buyer querying the travel details in the database and the buy detail;
assigning the package to the traveler for carrying from the first place to the second place;
determining that the traveler delivered the package to the buyer; and
upon determining that the traveler has delivered the package to the buyer, causing presentation of a control selectable by the traveler, wherein selection of the control facilitates redemption by the traveler of a monetary award for delivering the package to the buyer.

8. The system according to claim 7, wherein the first place and the second place are in different regions or different countries.

9. The system according to claim 8, wherein the system is further configured to implement the steps of:
providing a traveler interface on a traveler device for the plurality of travelers to provide the travel details;
permitting, through the traveler interface, the traveler to book a flight from the first place to the second place; and
determining a discount on an airfare of the flight booked by the traveler.

10. The system according to claim 7, wherein the system further configured to implement the steps of:
receiving of the package by the buyer from the traveler.

11. The system according to claim 7, wherein the system further configured to implement the steps of:
providing a buyer interface to receive the buy detail from the buyer; and
presenting an address of the traveler to receive the package from a seller.

12. The system according to claim 7, wherein the system further configured to implement the steps of:
providing a buyer interface to receive the buy detail from the buyer;
executing purchase of the package from a seller by an agent;
determining that the agent has received the package; and
upon determining that the agent has received the package, assigning the package to the traveler.
